(19) United States
(12) Patent Application Publication
(10) Pub. No.: US 2025/0083285 A1
(43) Pub. Date: Mar. 13, 2025

(54) RIGHT-ANGLE JOINT JIG

(71) Applicant: Rolando E. Garza, Chicago, IL (US)

(72) Inventor: Rolando E. Garza, Chicago, IL (US)

(21) Appl. No.: 18/885,529

(22) Filed: Sep. 13, 2024

Related U.S. Application Data
(60) Provisional application No. 63/538,115, filed on Sep. 13, 2023.

(51) Int. Cl. B25B 11/02

(52) U.S. Cl. CPC B25B 11/02

(57) ABSTRACT

A right angle joint jig for guiding the formation of a slot in a top surface of a wood panel and bolt hole in an end surface of the wood panel, the bolt hole aligned for a bolt to thread into a slot nut in the slot. The jig has a vertical front member that attaches to a front side of a worktable and a top panel that is pivotally connected to the front member from a horizontal use position to a raised position. An adjustable router guide frame attaches to a top side of the top panel to guide a plunge router in forming the slot in a workpiece placed on the worktable under the top panel. An adjustable drill guide attaches at the front side of the jig to vertically position a drill bushing for a drill bit to form the bolt hole in the workpiece.

### CROSS-REFERENCE

This application claims the domestic priority benefit of U.S. Provisional Application No. 63/538,115, filed Sep. 13, 2023 and entitled RIGHT-ANGLE JOINT JIG, the entirety of which is hereby incorporated by reference herein.

### FIELD OF THE DISCLOSURE

The present disclosure relates to a jig for modifying a workpiece to receive mechanical fasteners for joining the workpiece to another member. More particularly, it relates to a woodworking jig for modifying a piece of wood to receive mechanical fasteners for joining another member to an end or periphery of the piece of wood.

### SUMMARY

According to an aspect of the disclosure, a right-angle joint jig comprises a front member, a top panel, an adjustable router guide frame, and a drill guide. The front member is adapted and configured to be movably connected to a worktable for locking vertical adjustment movement. The top panel is connected to and extends rearwardly from an upper end of the front member, the top panel being adapted and configured to retain a workpiece between a bottom side of the top panel and a top side of the worktable when the front member is so connected to the worktable. The adjustable router guide frame is connected to a top side of the top panel. The router guide frame is adapted and configured to receive a plunge router having a horizontally oriented base and a plunge router bit with a rotational bit axis at fixed position relative to the plunge router base, so that the plunge router base is disposed on a top surface of the top panel within an adjustable horizontal planar guide frame area circumscribed by the router guide frame. A horizontal range of movement of the plunge router so received and disposed is determined by the guide frame area. The top panel has a small enough vertical thickness dimension to permit the plunge router so received and disposed to plunge the router bit into the workpiece so retained to an operative vertical level below a top surface of the workpiece, the router bit being operable by the plunge router to remove material of the workpiece disposed in a path of the router bit at the operative vertical level through the horizontal range of movement of the plunge router so as to form a slot over an area determined by a diameter of the router bit and said horizontal range of movement. The drill guide retains a drill bushing and is adapted and configured to produce vertical adjustment movement of the drill bushing relative to the workpiece so retained between the top panel and the worktable and to lock the vertical adjustment movement of the drill bushing at a selected vertical position of the drill bushing in front of the workpiece. The drill bushing in the selected vertical position is adapted and configured to guide a drill bit inserted therethrough so that the drill bit is operable to form a bore hole in the workpiece at a selected position on the front side of the workpiece.

### BRIEF DESCRIPTION OF THE DRAWINGS

Although the characteristic features of this disclosure will be particularly pointed out in the claims, the disclosed method and system, and how it may be made and used, may be better understood by referring to the following description taken in connection with the accompanying drawings forming a part hereof, wherein like reference numerals refer to like parts throughout the several views and in which:

FIG. 1 is an exploded perspective view of a pair of members connected by a right-angle joint formed using a right-angle joint jig of an embodiment of the disclosure.

FIG. 2 is a top plan view of a member of FIG. 1 having a bore hole and slot formed therein using the right-angle joint jig.

FIG. 3 is a perspective view of the right-angle joint jig used to form the right-angle joint of FIG. 1.

FIG. 4 is a top plan view of the right-angle joint jig of FIG. 3.

FIG. 5 is a front elevation view of the right-angle joint jig of FIG. 3.

FIG. 6 is a top plan view of a crosshairs insert for use with the right-angle joint jig of FIG. 3.

FIG. 7 is a truncated top plan view of the right-angle joint jig of FIG. 3 illustrating a use position of the crosshairs insert of FIG. 6.

FIG. 8 is a truncated bottom plan view of the right-angle joint jig of FIG. 3 illustrating the use position of the crosshairs insert of FIG. 6.

FIG. 9 is a top-front perspective view of a right-angle joint jig according to another embodiment.

FIG. 10 is a front view of a drill guide of the jig of FIG. 9.

A person of ordinary skill in the art will appreciate that elements of the figures above are illustrated for simplicity and clarity and are not necessarily drawn to scale. The dimensions of some elements in the figures may have been exaggerated relative to other elements to help to understand the present teachings. Furthermore, a particular order in which certain elements, parts, components, modules, steps, actions, events and/or processes are described or illustrated may not be required. A person of ordinary skill in the art will appreciate that, for simplicity and clarity of illustration, some commonly known and well-understood elements that are useful and/or necessary in a commercially feasible embodiment may not be depicted to provide a clear view of various embodiments per the present teachings.

### DETAILED DESCRIPTION

In the following description of various examples of embodiments of the disclosed right angle joint jig and method of forming a right angle joint, reference is made to the accompanying drawings, which form a part hereof, and in which are shown by way of illustration various examples of the disclosed subject matter. Other specific arrangements of parts, example devices, systems, and environments, can be used, and structural modifications and functional modifications can be made without departing from the scope of the disclosed subject matter.

As illustrated in the accompanying drawings and described herein, provided in the present disclosure is a right-angle joint jig and a method of using the right-angle joint jig to join two members together at a right angle using mechanical fasteners. By way of background, a common method of securely joining two members of a load-bearing structure, such as an article of furniture, is to form a bore hole extending through each member, align the bore holes, insert through a first end opening of the aligned bore holes a bolt shaft of a bolt, and connect a nut or other mating fastener to an end of the bolt opposite the head, at an second end opening of the bore holes opposite the first end opening. However, sometimes the desired configuration of two members to be joined does not provide any combined dimension of the two members that is short enough to be conveniently spanned by the length of a bolt. For example, in a typical right-angle joint between two generally “flat” wood pieces (i.e., wood boards or panels), a narrow “edge” face of a first piece abuts a broader “front” or “rear” face of a second piece, the edge face being normal to a long length or width dimension of the first piece that is longer than any practical length for a bolt. (For purposes of this disclosure, such a length or width dimension may be referred to as a “long dimension,” and directions extending along a long dimension as “longitudinal.”) In such cases, it is common to set a mating fastener transversely into a fastener cavity in the first piece formed at an interior point along the long dimension, where the mating fastener aligns with a bore hole that extends longitudinally into the first piece from the edge face. This allows the mating fastener to mate with a bolt that is inserted into the bore hole through the edge face. The fastener cavity is operative to restrain any longitudinal movement of the fastener set therein, while the bore hole is sized to restrain any transverse movement of the bolt set therein, so that the fastener and bolt are held in place in the slot cavity and bore hole, respectively, when inserted therein and mated together.

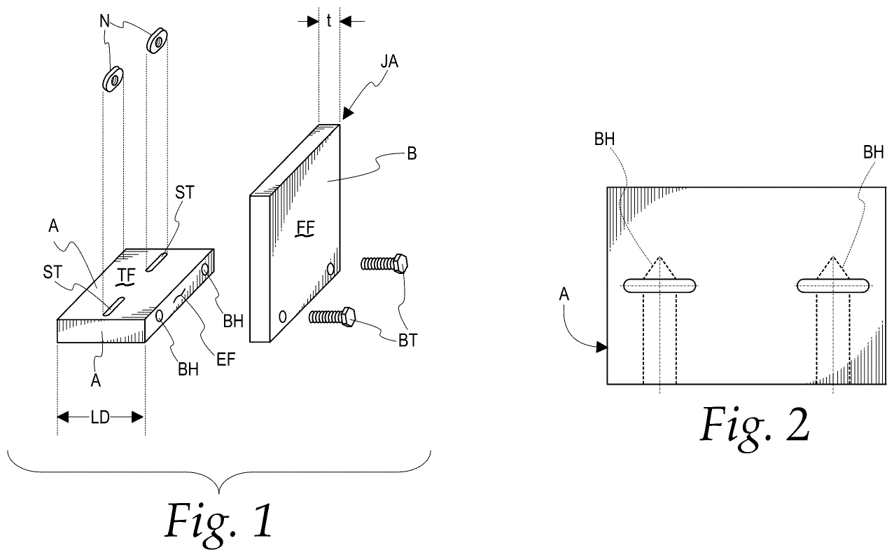

With reference to FIGS. 1 and 2, there is illustrated a joint assembly of a pair of members connected by a right-angle joint, which can be formed using a right-angle joint jig according to this disclosure. In particular, the illustrated joint assembly JA comprises a pair of members A and B in the form of flat panels. For example, the members A and B can be panels of a suitable material for use in constructing furniture items, such as bookcases, sofa or bed frames, including for example murphy bed frames. Suitable materials for the members A and B can include wooden materials, for example, cut lumber or manufactured wood materials such as medium-density fiberboard (MDF) or plywood. As shown in the exploded perspective view of FIG. 1, a pair of bore holes BH are formed in each of the members A and B for receiving a bolt BT inserted into a front face FF of the member B, through a thickness dimension t of the member B, and into an edge face EF of the member A, along a long dimension LD of the member A. The member B preferably includes a countersunk area around its bore holes BH (omitted for ease of illustration) to accommodate a head of each bolt BT, and according to an embodiment, a suitable cap or cover (not shown) is inserted into the countersunk hole to conceal and/or protect the bolt heads once the joint assembly JA is assembled. The member A includes a slot ST for each bore hole BH, the slot ST being a downwardly extending cavity of generally uniform horizontal cross section corresponding to the shape of an opening of the slot ST on a top face TF of the member A and extending into the member A in a normal direction to the top face TF so as to align with and intersect the corresponding bore hole BH (as best seen in the top plan view of the member A shown in FIG. 2), for receiving a slot nut N in the corresponding slot ST. In an embodiment, a peripheral space around the slot nut N in the slot ST can be potted/filled with a suitable adhesive/glue, such as after the corresponding bolt BT has been threaded into the slot nut N in the slot ST. Gluing the slot nut N in place in this manner can have several benefits, including reinforcing and stabilizing the right-angle joint, promoting durability of the joint by preventing shifting movement of the slot nut N or bolt BT that could otherwise cause wear of the members A, B and/or fatigue of the fasteners N, BT themselves, and facilitating reassembly of the joint assembly JA by preventing the slot nut N from falling out of the slot ST or becoming misaligned when the bolt BT has been removed for disassembly of the joint assembly JA.

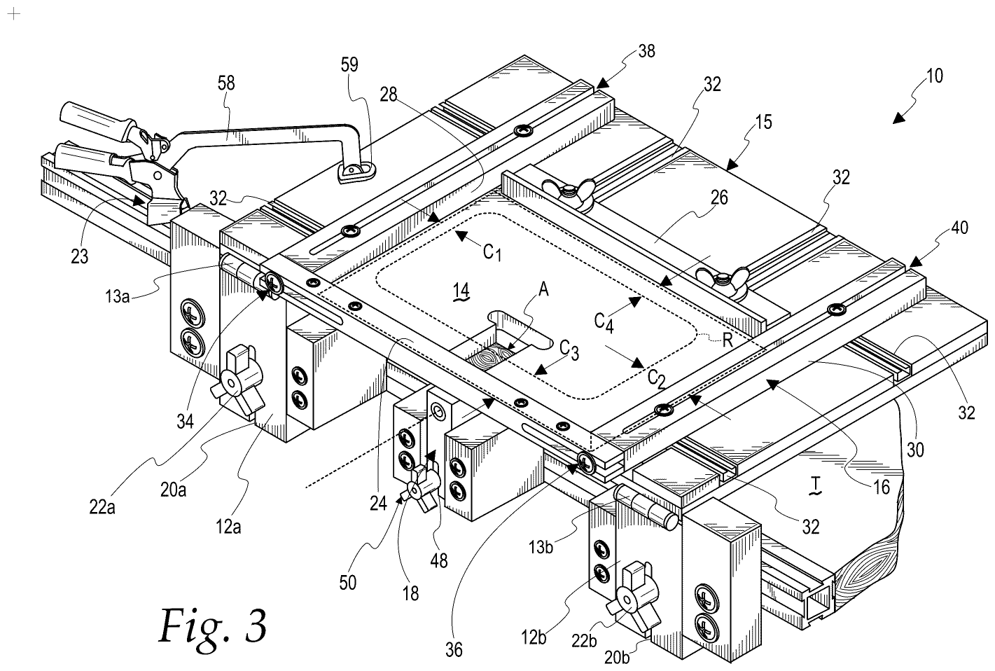

Turning to FIGS. 3-8, a right-angle joint jig 10 is illustrated. With reference to FIG. 3, the jig 10 includes left and right front legs 12a, 12b, a top panel 14, an adjustable router guide frame 16, and a drill guide 18. The front legs 12a, 12b are joined to a front side of the top panel 14 at laterally spaced apart positions, such as at opposite lateral sides of the top panel 14, the front legs 12a, 12b and top panel 14 collectively forming a base 15 of the jig 10, the base 15 being attachable to a front side of a suitable worktable at a rear side of the front legs 12a, 12b. More particularly, the front legs 12a, 12b are pivotally joined to the top panel by hinges 13a, 13b so as to allow the top panel 14 to pivot upwardly and forwardly from a generally horizontal use position, in which the top panel 14 is parallel to a top side of the worktable so attached; to a raised position, in which the top panel 14 is inclined upwardly away from the worktable, such as by nearly ninety degrees or ninety degrees; providing clear overhead access to facilitate placement and desired alignment relative to the drill guide 18 of a workpiece on the worktable under the use position of the top panel 14. The top panel 14 can then be pivoted downwardly and rearwardly back to the parallel use position, with a bottom side of the top panel 14 abutting a top side of the workpiece (which in a typical workpiece will be planar and parallel to a top side of the worktable, but use of the jig 10 with workpieces having other shapes, including irregular shapes, is not intended to be excluded from the scope of this disclosure) to align and stabilize the workpiece for boring and routing. In other embodiments not shown, front legs of a right-angle joint jig similar to the jig 10 can be fixedly joined at right angles to a top panel to form a one-piece base. In either case, the front legs 12a, 12b (or analogous fixed front legs of a one-piece base) are adapted and configured to be connected to a front side of the worktable with freedom of vertical adjustment, so that the bottom side of the top panel 14 (or analogous fixed top panel of a one-piece base) can be vertically raised to or above the height of a workpiece on the worktable, allowing the workpiece to be slid under the top panel to a desired position for boring and routing.

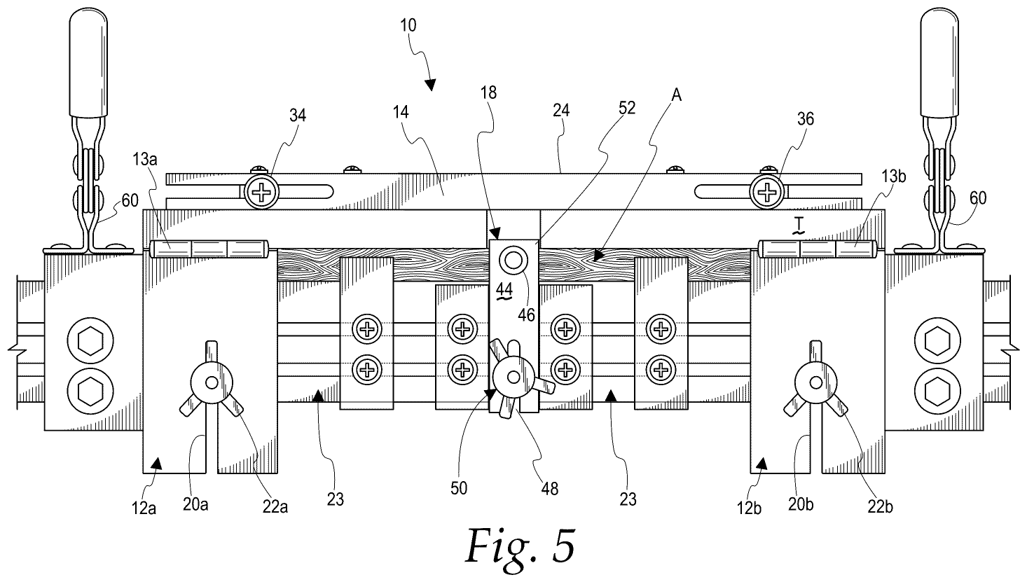

More particularly, as shown in FIGS. 3 and 5, the front legs 12a, 12b include open-ended slots 20a, 20b that extend upwardly from their respective lower ends for receiving a pin of a corresponding vertical adjustment lock 22a, 22b (shown also to include twist knobs that screw onto the pin). The slots 20a, 20b allow the top panel 14 to float over a workpiece (shown as the member A of the joint assembly JA that was illustrated and described with reference to FIGS. 1 and 2, also referred to here as the “workpiece A”) that is placed on a worktable T and aligned for drilling a bore hole and routing a slot as will be described in more detail below, while the locks 22a, 22b allow the vertical position of the top panel 14 to be fixed. For example, securing the locks 22a, 22b can lock the vertical position of the top panel 14 with its bottom side at the height of the workpiece A, so as to passively clamp the top panel 14 over the workpiece A for drilling the bore hole BH. (In the illustrated embodiment, such passive clamping would fix the vertical positions of the hinges 13a, 13b but rely on the weight of the top panel 14 to grip the workpiece A at positions displaced from the hinge axes; thus, as desired, active clamping can be provided by clamps 58, as shown in FIG. 3 and described further below.) The locks 22a, 22b can also be used to secure the top panel 14 at a vertical clearance position above the workpiece A, to allow the workpiece A to be freely moved horizontally for alignment with the jig 10 prior to drilling and routing, and/or to be freely removed from under the top panel 14 after drilling and routing, particularly in alternative one-piece base embodiments as described above, in which a top panel cannot be pivoted to allow a workpiece to be removed. In the illustrated embodiment, the worktable T includes horizontal sliding tracks 23 along its front face, to which the locks 22a, 22b may be engaged, further allowing a lockable adjustment of the lateral position of the entire base 15 of the jig 10 when used with the worktable T or a similar worktable.

The router guide frame 16 includes a front guide member 24, a rear guide member 26, a left guide member 28, and a right guide member 30. The front and rear guide members are movably connected to the top panel 14 for locking forward and rearward position adjustments and the left and right guide members 28, 30 are movably connected to the top panel 14 for locking leftward and rightward position adjustments. In the illustrated embodiment, position adjustments of the rear, left and right guide members 26-30 are provided by lockable sliding connections between each guide member 26-30 and a respective track segment 32 set into the top panel 14. The front guide member 24, on the other hand, is not connected directly to the top panel 14, but rather only to the left and right guide members 28, 30. In particular, the depth (forward-rearward or anteroposterior) coordinate position of the front guide member 24 is locked to that of left and right guide members 28, 30, while the latter are free to move laterally relative to the front guide member 24 by respective slot joints 34, 36. In turn, forward and rearward adjustments of the front guide member 24 are provided by respective locking slot joints 38, 40 formed in the left and right guide members 28, 30 and connecting the latter to the top panel 14. It will be understood that the linkage just described is one of many possible arrangements of front, rear, left, and right guide members and a top panel that would allow for locking forward and rearward position adjustments of the front and rear guide members relative to the top panel and locking leftward and rightward position adjustments of the left and right guide members relative to the top panel. For example, it could be a rear guide member instead of a front guide member that has its depth position locked to that of a pair of left and right guide members, while a front guide member is directly connected to the top panel by a sliding joint. In other embodiments, it could be front and rear guide members that have two lockable degrees of freedom relative to a top panel, one of the left and right guide members being directly connected to the top panel by a sliding joint, and the other having its lateral position locked to that of the front and rear guide members. In still other embodiments, each of four guide members could be directly connected to the top panel, each of a left and right pair of the members having one degree of freedom to move in a lateral dimension and each of a front and rear pair of the members having one degree of freedom to move in a depth dimension orthogonal to the lateral dimension.

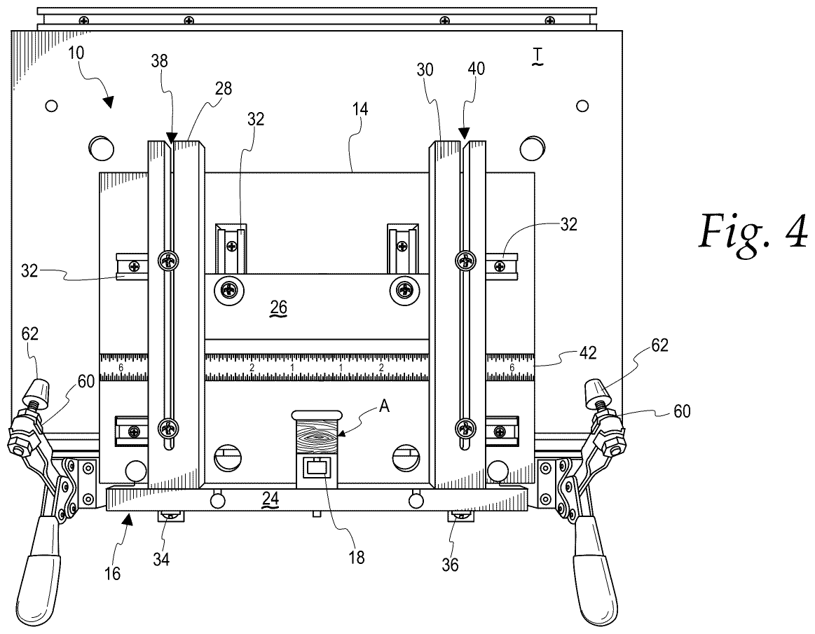

With reference to FIG. 3, there is shown projected onto the top panel 14 a base frame outline R of a plunge router (the plunge router having the frame outline R also being referred to here as the “plunge router R”), at left and right lateral clearances C₁ and C₂ and forward and rearward depth clearances C₃ and C₄ from the respective left, right, front, and rear guide members 28, 30, 24, 26. The plunge router R will be understood to be adapted to have a routing bit attached thereto that extends downwardly at a fixed position within the area circumscribed by the frame outline R, which can for example be the center of the area (not shown). It will be readily understood that the sum of the lateral clearances C₁ and C₂ plus a router bit diameter determines a width, and the sum of the depth clearances C₃ and C₄, plus the router bit diameter, determines a depth (anteroposterior dimension), of a generally rectangular slot (with rounded corners of a radius corresponding to that of the routing bit used) that can be formed in a top side of the workpiece A by operating the plunge router R while moving it through a full range of motion permitted by the guide frame 16. Likewise, it will be understood that the position of the slot can be adjusted without altering its width or depth dimension by shifting the left-right pair of guide members 28, 30 together by an equal left or right lateral distance and/or by shifting the front-rear pair of guide members 24, 26 by an equal forward or rearward distance. As shown in FIG. 4, one or more rulers 42 (one shown, oriented laterally) can be set into the top panel 14 to facilitate measuring guide member adjustments in the lateral and/or depth dimension. Applying the foregoing adjustments, a user can set the guide members 24-30 plunge router R to form a slot through a desired area of a top side of the workpiece A. The top panel 14 includes an opening 43 to expose an area of the top side of the workpiece A to a routing bit of the plunge router R. The opening 43 can be sized to permit the formation of any desired slot within the exposed area. Alternatively, in embodiments, the top panel 14 (or at least portions of the top panel 14 in a region adjacent the opening 43) can be formed of a “routable” material, such as a suitable wood material, that can be removed by the router R so as to expand the opening 43 as needed to form portions of a slot that extend beyond an area currently exposed by the opening 43.

The drilling aspect of the jig 10 will now be described in more detail, continuing to refer to FIGS. 3-5. With particular reference to FIG. 5, the drill guide 18 is shown to include a housing 44 and a drill bushing 46 retained in the housing 44. The housing 44 has a vertical slot 48 formed in its lower end which cooperates with an adjustment lock 50 (shown as a twist knob screwed onto a pin received in the slot 48) to form a slot joint connecting the drill guide 18 to the worktable T with locking vertical position adjustment. As illustrated, the adjustment lock 50 is engaged to one of the horizontal sliding tracks 23 on the front face of the worktable T so as to also permit lateral positional adjustment of the drill guide 18. The drill guide 18 can include alignment indicia 52, such as lines marked or engraved thereon as illustrated. The indicia 52 can include vertical and horizontal lines on a front face of the housing 44, the horizontal line extending from the front face over lateral faces of the housing 44, and the vertical line extending from the front face over a top face of the housing 44, each line extending to the rear side of the housing 44 to indicate the horizontal and vertical coordinates of the center of the bushing 46. Corresponding lines or markings can be drawn on a front face of the workpiece A (not shown) to indicate the center position of a desired bore hole. Prior to lowering the top panel 14 onto the workpiece A (or otherwise clamping the workpiece A to fix its position relative to the jig 10 and/or the worktable T, as described below), the workpiece A can be moved manually so as to align its vertical or top surface line or marking with that of the indicia 52, thereby horizontally aligning the center of the bushing 46 with that of the desired bore hole. Then, the vertical position of the drill guide 18 can be adjusted and locked using vertical adjustment lock 50 to align its horizontal line with that marked on the workpiece A, thereby vertically aligning the center of the bushing 46 with that of the desired bore hole, followed by drilling the a bore hole in the workpiece A with a drill bit inserted through the bushing 46 to form a bore hole centered at the desired lateral and vertical coordinates.

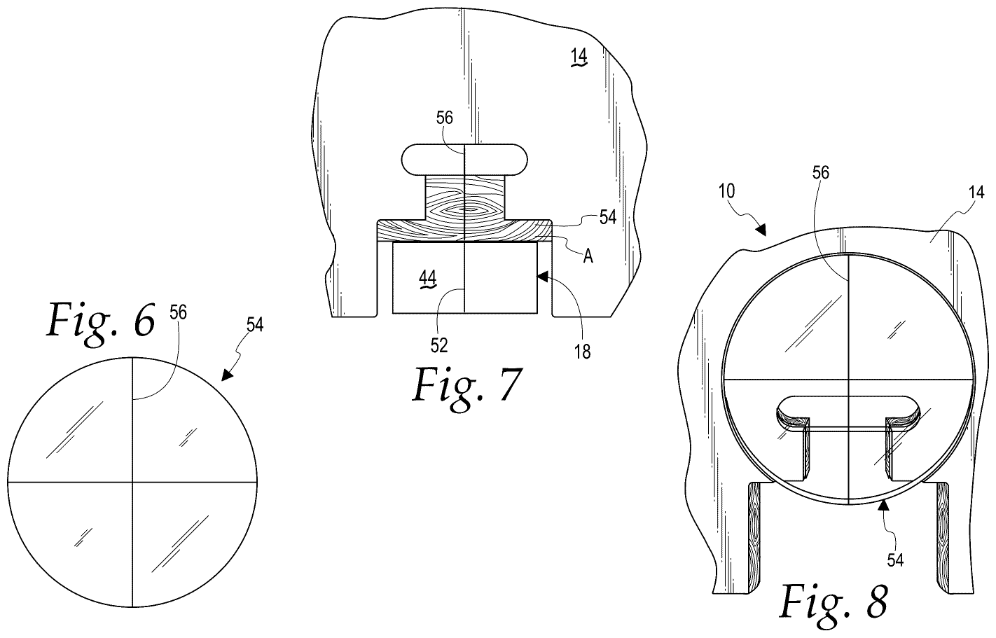

To help guide the positioning of the workpiece A for drilling and/or routing, the jig 10 can include a sight guide insert 54 as illustrated in FIGS. 6-8. The sight guide insert 54 is shown separately in FIG. 6 as a disk made of a suitable translucent material (such as acrylic), having crosshairs 56 visible on or through its top surface (such as by being marked or drawn thereon or on its bottom surface). With the sight guide insert 54 set into a countersunk space on a bottom side of the top panel 14 (as shown in FIG. 8) and the drill guide 18 mounted to a lateral position along one of the sliding tracks 23 to align the lateral coordinate of the center of the drill bushing 46 with a longitudinal (forward-rearward) one of the crosshairs 56, a line or marking made on the top side of the workpiece A to indicate the desired position of a bore hole axis can be aligned with the longitudinal crosshair 56 to ensure that the workpiece A is correctly positioned laterally and correctly rotated in the horizontal plane (the latter may not be ensured simply by abutting a front side or edge of a workpiece against the rear side of the drill guide housing 44 or otherwise aligning the front side or edge of the workpiece laterally, as an end face of the workpiece may not be perpendicular to the desired bore hole axis, such as due to an imperfection resulting in the workpiece end face not being perfectly flat or not being perpendicular to its own lateral sides, and/or when it is in fact desired for the bore hole axis to be oblique to one or more sides of the workpiece) to align the desired bore hole axis with the center of the drill bushing 46.

The jig 10 can further include one or more workpiece clamps, such as the workpiece clamp 58 shown in FIG. 3 or the workpiece clamps 60 shown in FIGS. 4 and 5. The workpiece clamp 58 is connected to a top side of the worktable T and includes a clamping end 59 that is adapted and configured to rotate downwardly in a vertical plane so as to press down on the top panel 14 of the jig 10 when the clamp 58 is engaged, thereby applying a holding force to a workpiece positioned between the worktable T and the top panel 14. When disengaged, the clamp 58 can be rotatable in a horizontal plane and/or movable along the track 23 in lateral directions to be positioned as desired for clamping down either against the top panel 14 or against a workpiece directly, when a portion of the workpiece extends beyond the lateral span of the top panel 14.

Each workpiece clamp 60 shown in FIGS. 4 and 5 is connected to the worktable T in a fixed position at one end and includes a clamping end 62 that is adapted and configured to rotate downwardly in a vertical plane so as to press down directly against a workpiece that extends laterally beyond the lateral span of the top panel 14.

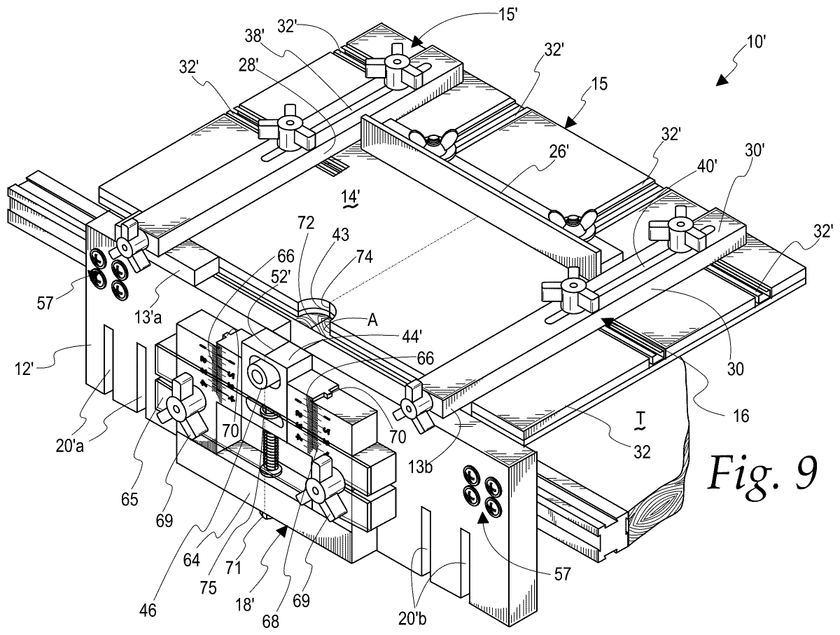

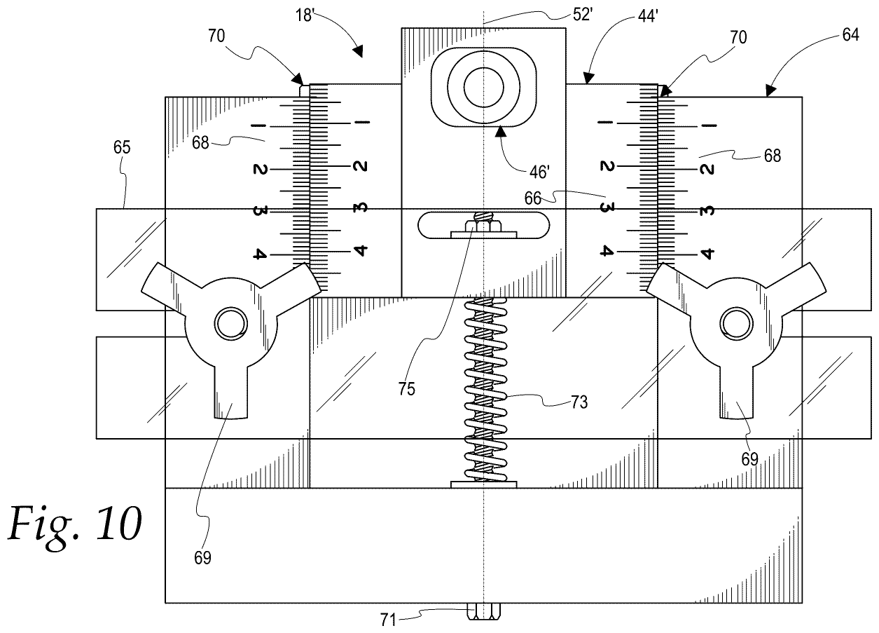

A right-angle joint jig 10′ according to another embodiment is now described with reference to FIGS. 9 and 10. The jig 10′ includes a front panel 12′ and a top panel 14′, the front panel 12′ having a top side joined to a front side of the top panel 14′ to form a base 15′ comprising the front panel 12′ and the top panel 14′. The jig 10′ further includes an adjustable router guide frame 16′ movably connected to the top panel 14′, and a drill guide 18′ connected to the front panel 12′. The base 15′ is attachable to a front side of a suitable worktable T′ at a rear side of the front panel 12′, such as with the front panel 12′ affixed perpendicularly to a top side of the worktable T′ as shown in FIG. 9. More particularly, the front panel 12′ is pivotally joined to the top panel by hinges 13′a, 13′b so as to allow the top panel 14′ to pivot upwardly and forwardly from a generally horizontal use position (shown in FIG. 9), in which the top panel 14′ is parallel to the top side of the worktable T′ with the base 15′ so attached; to a raised position (not shown), in which the top panel 14′ is inclined upwardly away from the worktable T′, such as by as much as nearly ninety degrees or ninety degrees. The top panel 14′ in the raised position allows clear overhead access to facilitate placement and desired alignment relative to the drill guide 18′ of a workpiece on the worktable T′ under the use position of the top panel 14′. The top panel 14′ can then be pivoted downwardly and rearwardly back to the parallel use position, with a bottom side of the top panel 14′ abutting a top side of the workpiece A to align and stabilize the workpiece for boring and routing. It will be understood that the jig 10′ as shown in FIG. 9 is particularly adapted and configured for stabilizing in this manner a workpiece of generally uniform thickness with generally planar and parallel top and bottom sides, such as the member A as shown (described and illustrated above with reference to joint assembly JA of FIGS. 1 and 2). In other embodiments not shown, a front panel of a right-angle joint jig similar to the jig 10′ can be fixedly joined at right angles to a top panel to form a one-piece base. In either case, the front panel 12′ or analogous fixed front panel is adapted to be connected to a front side of the worktable with freedom of vertical adjustment, so that the bottom side of the top panel 14′ or analogous fixed top panel of a one-piece base can be vertically raised to or above the height of a workpiece on the worktable, allowing the workpiece to be slid under the top panel to a desired position for boring and routing.

More particularly, as shown in FIG. 9, the front panel 12′ includes open-ended vertical adjustment slots 20′a, 20′b that extend upwardly from their respective lower ends for receiving a pin of a corresponding vertical adjustment lock (which is not shown but can for example be analogous to the knobs 22a, 22b of the jig 10 described above). The vertical adjustment slots 20′a, 20′b allow the top panel 14′ to float over the member A on the worktable T′ to be aligned for drilling a bore hole and routing a slot as will be described in more detail below. For example, locking the vertical adjustment 20′a, 20′b of the top panel 14′ with its bottom side at the height of the workpiece A, so as to passively clamp the top panel 14′ over the workpiece A for drilling the bore hole BH. In the illustrated embodiment, such passive clamping would fix the vertical positions of the hinges 13′a, 13′b but rely on torque produced by the weight of the top panel 14′ to grip the workpiece A at positions displaced from the hinge axes; thus, as desired, active clamping can be provided by clamps analogous to clamps 58 as shown in FIG. 3. Alternatively or additionally, a suitable clamp such as the clamps 60 shown in FIGS. 4 and 5 can be secured to one or more clamp mounts 57 on the front panel 12′ such that the clamping end 62 is disposed to clamp down on the top side of the top panel 14′ when the clamp 60 is operated, thereby locking the top panel 14′ in its horizontal use position. Thus, by first locking the vertical adjustment 20′a, 20′b at a position wherein the top panel 14′ in the use position is set with its bottom side at or slightly below the nominal height of the workpiece A above the table T′ and then operating the clamps 60 secured in such a manner to the front panel 12′, the workpiece A can be clamped between the top panel 14′ and the worktable T′ by the torque applied by the clamps 60 to the pivotal joints 13′a, 13′b, without the need for any clamp to be secured directly to the worktable T′.

As in the previous embodiment, the vertical adjustment slots 20′a, 20′b can also be used to secure the top panel 14 at a vertical clearance position above the workpiece A, to allow the workpiece A to be freely moved horizontally for alignment with the jig 10′ prior to drilling and routing, and/or to be freely removed from under the top panel 14′ after drilling and routing, particularly in alternative one-piece base embodiments as described above, in which a top panel cannot be pivoted to allow a workpiece to be removed. Also similarly to the previous embodiment, the worktable T′ includes horizontal sliding tracks along its front face, analogous to the tracks 23 shown in FIG. 3, which can receive an end of a suitable vertical adjustment locking bolt (not shown, analogous to vertical adjustment locks 22a, 22b shown in FIG. 3) that extends through the vertical adjustment slots 20′a, 20′b, further allowing sliding adjustment of the lateral position of the entire base 15′ of the jig 10′ when used with the worktable T′ or a similar worktable.

The drilling aspect of the jig 10′ will now be described in more detail, referring to FIGS. 9 and 10. With particular reference to FIG. 10, the drill guide 18′ is shown to include a housing 44′ and a drill bushing 46′ retained in the housing 44′. The housing 44′ is retained by a suitable vertical sliding joint, such as the illustrated tongue-and-groove joint 70, in a drill guide base 64. The base 64 is affixed to the front panel 12′ by mounting bolts that are tightened and loosened manually by respective knobs 69. In turn, the housing 44′ can be biased upwardly relative to the base 64 by a suitable biasing component such as the spring 73.

As illustrated, each of the drill guide housing 44′ and the drill guide base 64 is ruled to show a vertical adjustment position of the housing 44′ relative to the base 64, the base 64 being affixed to the front panel 12′, the front panel 12′ being in turn only pivotally movable relative to the top panel 14′ and therefore fixed vertically relative to a bottom surface of the top panel 14′ in the use position, which in turn is disposed at the vertical position of the top side of the workpiece A onto which it is clamped. Thus, the vertical position of the drill guide housing 44′ relative to the drill guide base 64 determines the vertical position of the drill bushing 46′ relative to the top side of the workpiece A. In a method according to an embodiment, precise vertical alignment of the drill bushing 46′ is additionally or alternatively facilitated by a visual marking (not shown) made on a front face of the workpiece A. Such a marking can be aligned visually by looking through a center of the bushing 46′ and/or by inserting a drill bit through the bushing 46′ and confirming that a tip of the drill bit touches the marking on the workpiece A before beginning drilling to form the bore hole BH. The vertical adjustment of the housing 44′ can be locked by tightening the knobs 69 to clamp the housing 44′ and the base 64 between a clear panel insert 65 and the front panel 12′ of the jig 10′, as seen in FIG. 9. When so locked, vertical adjustment by pressing down or pulling up on the housing 44′ by hand is substantially prevented by a static frictional holding force applied to the housing 44′ by the clear panel insert 65. In other embodiments, a frictional holding force can be provided in another way, such as, for example, by adjusting a set screw (not shown) retained by one of the housing 44′ and the base 64 so as to engage the other, or by applying a clamping force (by means not shown) to the upper ends of the U-shaped body of the base 64 so as to flex them towards each other to grip the housing 44′. In the illustrated embodiment, the drill guide 18′ further includes a fine-adjustment dial 71. Rotating the fine adjustment dial 71 turns a threaded bolt to produce a sufficient vertical force on a fine adjustment nut 75 retained in the housing 44′ (as seen in FIG. 10) to overcome the static frictional holding force, thus permitting fine adjustments to be made after performing and then frictionally locking an initial approximate direct manual adjustment.

Lateral position adjustment of the drill guide 18′ can be performed by sliding the entire jig base 15′ left or right along the track of the worktable T′ and/or by moving the workpiece A left or right on the worktable T′ (typically with the top panel 14′ pivoted to a raised position, or in an embodiment with a one-piece jig base, with the jig adjusted vertically to provide a clearance between its top panel and a workpiece on a worktable). To assist with lateral alignment in a method according to an embodiment, a guide marking 72 drawn on a top surface of the workpiece A is aligned visually with a guide marking 74 formed on the top panel 14′ and with a guide marking 52′ formed on a top side of the drill guide housing 44′. Typically, and as shown in FIG. 9, there may be a clearance gap between the guide marking 52′ and the guide marking 72, in which case a suitable straightedge (not shown) can be placed spanning the clearance gap to assist with visual alignment of the markings 52′ and 72, by aligning each with the straightedge.

The preceding description of the disclosure has been presented for purposes of illustration and description and is not intended to be exhaustive or to limit the disclosure to the precise form disclosed. The description was selected to best explain the principles of the present teachings and the practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification but be defined by the claim(s) set forth below. In addition, although narrow claims may be presented below, it should be recognized that the scope of this disclosure is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional disclosures are not dedicated to the public and the right to file one or more applications to claim such additional disclosures is reserved.

What is claimed is:

1. A right-angle joint jig comprising:
a front member adapted and configured to be movably connected to a worktable for locking vertical adjustment movement;
a top panel connected to and extending rearwardly from an upper end of the front member, the top panel being adapted and configured to retain a workpiece between a bottom side of the top panel and a top side of the worktable when the front member is so connected to the worktable;
an adjustable router guide frame connected to a top side of the top panel, the router guide frame being adapted and configured to receive a plunge router having a horizontally oriented base and a plunge router bit with a rotational bit axis at fixed position relative to the plunge router base, so that the plunge router base is disposed on a top surface of the top panel within an adjustable horizontal planar guide frame area circumscribed by the router guide frame, so that a horizontal range of movement of the plunge router so received and disposed is determined by the guide frame area, the top panel having a small enough vertical thickness dimension to permit the plunge router so received and disposed to plunge the router bit into the workpiece so retained to an operative vertical level below a top surface of the workpiece, the router bit being operable by the plunge router to remove material of the workpiece disposed in a path of the router bit at the operative vertical level through the horizontal range of movement of the plunge router so as to form a slot over an area determined by a diameter of the router bit and said horizontal range of movement; and
a drill guide, the drill guide retaining a drill bushing and being adapted and configured to produce vertical adjustment movement of the drill bushing relative to the workpiece so retained between the top panel and the worktable and to lock the vertical adjustment movement of the drill bushing at a selected vertical position of the drill bushing in front of the workpiece, the drill bushing in the selected vertical position being adapted and configured to guide a drill bit inserted therethrough so that the drill bit is operable to form a bore hole in the workpiece at a selected position on the front side of the workpiece.

2. The right-angle joint jig of claim 1 wherein the drill guide further comprises a drill guide housing, the drill guide housing retaining the drill bushing and being movably connected to a front side of the worktable for vertical movement of the drill guide housing relative to the worktable to produce said vertical adjustment movement of the drill bushing relative to the workpiece.

3. The right-angle joint jig of claim 1 wherein the drill guide further comprises a drill guide housing and a drill guide base, the drill guide base being affixed to the front member, the drill guide housing being movably connected to the drill guide base for vertical movement relative to the drill guide base to produce said vertical adjustment movement of the drill bushing relative to the workpiece.

4. The right-angle joint jig of claim 3 wherein the drill guide is adapted and configured to permit the drill guide housing to be moved vertically relative to the drill guide base by a user directly applying a manual downward or upward force to the drill guide housing to produce said vertical adjustment movement.

5. The right-angle joint jig of claim 4 wherein the drill guide further comprises a frictional adjustment locking member, the frictional adjustment locking member being selectively engageable to press against the drill guide housing in a horizontal direction so as to provide a static frictional holding force to resist said vertical movement of the drill guide housing relative to the drill guide base.

6. The right-angle joint jig of claim 5 wherein the drill guide further comprises a fine-adjustment dial, the fine adjustment dial being operative to convert rotational movement into a sufficient force on the drill guide housing to overcome said static frictional holding force.

7. The right-angle joint jig of claim 1 wherein the router guide frame comprises a plurality of guide frame members, each guide frame member being movably connected to the top panel for horizontal planar adjustment movements to adjust clearances between the router base and the router guide frame members in each of two orthogonal directions in the horizontal plane.

8. The right-angle joint jig of claim 7, the guide frame members including a first pair of opposed guide frame members and a second pair of opposed guide frame members, the first pair of opposed guide frame members being independently movable relative to the top panel in a first of the two orthogonal directions to independently set each extreme of a continuous range of motion of the router base in the first orthogonal direction, and the second pair of opposed guide frame members being independently movable relative to the top panel in the second orthogonal direction to independently set each extreme of a continuous range of motion of the router base in the second orthogonal direction.

9. The right-angle joint jig of claim 7 wherein the guide frame area is a rectangular area having a leftwardly and rightwardly extending lateral dimension and a forwardly and rearwardly extending depth dimension, the guide frame members being movable so as to independently adjust the lateral dimension, the depth dimension, a position in the lateral directions, and a position in the depth directions of the rectangular guide frame area.
